(19) United States
(12) Patent Application Publication
(10) Pub. No.: US 2019/0293151 A1
(43) Pub. Date: Sep. 26, 2019

(54) POWER TRANSMISSION SYSTEM

(71) Applicant: AISIN AI CO., LTD., Nishio-shi (JP)

(72) Inventors: Yosuke HAYASHI, Toyota-shi (JP); Takeshige MIYAZAKI, Chiryu-shi (JP); Daisuke SAITO, Okazaki-shi (JP); Atsushi SUZUKI, Aichi-ken (JP)

(73) Assignee: AISIN AI CO., LTD., Nishio-shi (JP)

(21) Appl. No.: 16/217,815

(22) Filed: Dec. 12, 2018

(30) Foreign Application Priority Data
Mar. 26, 2018 (JP) 2018-059035

(51) Int. Cl. F16H 3/089; F16H 3/10; F16D 23/04; F16D 11/14; B60L 15/20

(52) U.S. Cl. CPC F16H 3/089; F16H 3/10; F16H 2003/0818; F16D 11/14; B60L 15/20; F16D 23/04

(57) ABSTRACT

A power transmission system includes a control device that controls a motor generator, a synchronizing mechanism, and a clutch mechanism such that at least one of the synchronizing mechanism and the clutch mechanism constantly transmits power between a first shaft and a second shaft during a gear switch from a first-speed gear to a second-speed gear and the motor generator constantly generates torque for a period from operation start of each of the synchronizing mechanism and the clutch mechanism to a power transmission state of the synchronizing mechanism.

### CROSS-REFERENCE TO RELATED APPLICATIONS

This application is based upon and claims the benefit of priority from Japanese Patent Application No. 2018-059035, filed Mar. 26, 2018, the entire contents of which are incorporated herein by reference.

### FIELD

Embodiments described herein relate generally to a power transmission system.

### BACKGROUND

Conventionally, transmissions include an input shaft, an output shaft, multiple gears including a drive gear rotatably attached to the input shaft and a driven gear fixed to the output shaft, and a clutch mechanism for selecting a gear to which power is transmitted (disclosed in Japanese Laid-open Patent Application Publication No. 2013-24391 and German Patent Application Publication No. DE 102013108300 A1, for example).

Such a transmission is placed in neutral state to transmit no power, at the time of a gear switch for the acceleration of a vehicle, for example. This may drastically change the acceleration of the vehicle, exerting impact on the vehicle.

An object of the present invention is to provide a power transmission system that can prevent a vehicle from being affected by impact due to a gear switch, for example.

### SUMMARY

In general, according to one embodiment, a power transmission system includes a transmission that is located between a motor generator and a wheel both of which are mounted on a vehicle, and a control device. The transmission includes a first shaft that is rotatable; a second shaft that is rotatable and parallel to the first shaft; a first-speed gear having a first gear and a second gear, the first gear rotatably attached to the first shaft, the second gear attached to the second shaft to mesh with the first gear and integrally rotate with the second shaft; a second-speed gear being smaller in gear ratio than the first-speed gear and having a third gear and a fourth gear, the third gear rotatably attached to the first shaft, the fourth gear attached to the second shaft to mesh with the third gear and integrally rotate with the second shaft; a synchronizing mechanism that is interposed between the first shaft and the third gear and to be switched between a power transmission state and a power shut-off state, the power transmission state being a state in which the synchronizing mechanism generates friction force that causes a rotation speed of the first shaft and a rotation speed of the third gear to approach each other, the power shut-off state being a state in which the synchronizing mechanism generates no friction force; and a clutch mechanism that switches transmission and non-transmission of rotation between the first shaft and the first gear and between the first shaft and the third gear. One of the first shaft and the second shaft is connected to the motor generator and the other is connected to the wheel. The control device controls the motor generator, the synchronizing mechanism, and the clutch mechanism such that at least one of the synchronizing mechanism and the clutch mechanism constantly transmits power between the first shaft and the second shaft during a gear switch from the first-speed gear to the second-speed gear, and that the motor generator constantly generates torque for a period from when each of the synchronizing mechanism and the clutch mechanism starts operating to when the synchronizing mechanism is placed in the power transmission state.

With such a configuration, for example, at least one of the clutch mechanism and the synchronizing mechanism constantly transmits the power of the motor generator between the first shaft and the second shaft during a gear switch from the first-speed gear to the second-speed gear and the motor generator constantly generates the torque for the period from when each of the synchronizing mechanism and the clutch mechanism starts operating to when the synchronizing mechanism is placed in the power transmission state. This can prevent the vehicle from being affected by impact due to the gear switch. Also, the acceleration of the vehicle can be prevented from falling to zero at the time of a gear switch from the first-speed gear to the second-speed gear while the vehicle is accelerating.

According to the power transmission system, for example, the synchronizing mechanism includes a first cone face of the third gear, that integrally rotates with the third gear; a synchronizer ring having a second cone face that is pressed against the first cone face to generate friction force with the first cone face; and a first sleeve that is movable along an axis of the first shaft between a press position and a non-press position, and integrally rotates with the first shaft. The press position is a position in which the second cone face is pressed against the first cone face. The non-press position is a position in which the second cone face is not pressed against the first cone face. The first sleeve is movable from the non-press position to the press position while the clutch mechanism transmits rotation between the first shaft and the first gear and transmits no rotation between the first shaft and the third gear. The clutch mechanism is configured to transmit rotation between the first shaft and the first gear while the first sleeve moves from the non-press position to the press position.

With such a configuration, for example, the first sleeve is movable to the press position from the non-press position while the clutch mechanism transmits rotation between the first shaft and the first gear and transmits no rotation between the first shaft and the third gear, and the clutch mechanism can transmit rotation between the first shaft and the first gear while the first sleeve moves from the non-press position to the press position. This makes it possible to prevent no transmission of the power between the first shaft and the second shaft at the time of a gear switch from the first-speed gear to the second-speed gear for acceleration of the vehicle.

According to the power transmission system, for example, the first shaft and the first gear are rotated in a first direction by power of the motor generator. The clutch mechanism includes a one-way clutch that is located between the first shaft and the first gear, transmits rotation in the first direction from the one of the first shaft and the second shaft to the other, and allows the other to rotate in the first direction relative to the one of the first shaft and the second shaft.

With such a configuration, the one-way clutch can transmit rotation between the first shaft and the first gear while the first sleeve moves from the non-press position to the press position.

According to the power transmission system, for example, the first-speed gear and the second-speed gear are spaced apart from each other along the axis of the first shaft. The clutch mechanism includes first teeth that integrally rotate with the first gear; second teeth that integrally rotate with the third gear; a first movable part that includes third teeth, is located between the first gear and the third gear, is movable along the axis of the first shaft between a first mesh position and a first non-mesh position, and integrally rotates with the first shaft, the first mesh position being a position in which the third teeth and the first teeth mesh with each other, the first non-mesh position being closer to the third gear than the mesh position and being a position in which the third teeth and the first teeth do not mesh with each other; a second movable part that includes fourth teeth, is located between the first gear and the third gear, is movable along the axis of the first shaft between a second mesh position and a second non-mesh position and integrally rotates with the first shaft, and presses the second cone face against the first cone face while moving from the second non-mesh position to the second mesh position, the second mesh position being a position in which the fourth teeth and the second teeth mesh with each other, the second mesh position being closer to the first gear than the mesh position, and being a position in which the fourth teeth and the second teeth do not mesh with each other; and a driver that connects the first movable part and the second movable part, generates force to move the first movable part to the first non-mesh position when the first movable part is located in the first mesh position and the second movable part is located in the second non-mesh position, and moves the first movable part to the non-mesh position by the force along with the motion of the second movable part to the second mesh position to press the second cone face against the first cone face.

With such a configuration, the first movable part can transmit rotation between the first shaft and the first gear while the first sleeve moves from the non-press position to the press position.

### BRIEF DESCRIPTION OF THE DRAWINGS

FIG. 1 is an exemplary diagram illustrating the schematic configuration of a vehicle in a first embodiment;

FIG. 2 is an exemplary block diagram illustrating the schematic configuration of the vehicle in the first embodiment;

FIG. 3 is an exemplary timing chart illustrating an example of the operation of the vehicle in the first embodiment;

FIG. 4 is an exemplary diagram illustrating the schematic configuration of a vehicle in a second embodiment; and

FIG. 5 is an exemplary diagram illustrating the schematic configuration of a vehicle in a third embodiment.

### DETAILED DESCRIPTION

Hereinafter, exemplary embodiments of the present invention will be disclosed. In the present specification, ordinal numbers are used for distinguishing parts, locations, and the like, and not intended to indicate order or priority. The following embodiments include like or same components. Common reference numerals denote the same or like components and redundant description thereof is omitted.

### First Embodiment

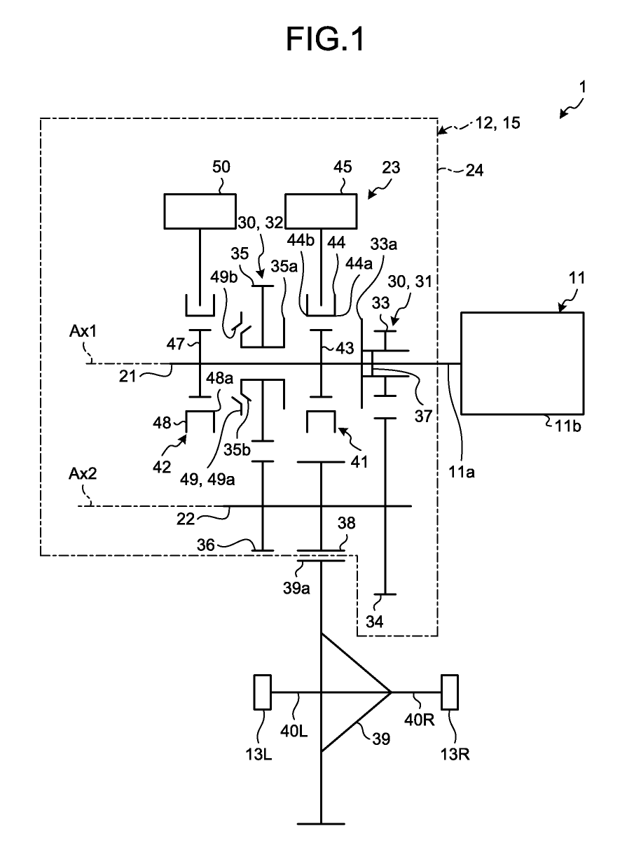

FIG. 1 is an exemplary diagram illustrating the schematic configuration of a vehicle 1 in a first embodiment. As illustrated in FIG. 1, the vehicle 1 includes a motor generator 11 as a driving source, a transmission 12, wheels 13L and 13R being driving wheels, and wheels (not illustrated) being driven wheels. The power of the motor generator 11 is transmitted to the wheels 13L and 13R through the transmission 12 to rotate the wheels 13L and 13R, whereby the vehicle 1 runs.

The motor generator 11 includes a shaft 11a and a case lib. The shaft 11a is rotatably supported by the case 11b about a first rotational center Ax1. The case 11b is supported by a body (not illustrated) of the vehicle 1. The case 11b accommodates a rotor (not illustrated) that rotates integrally with the shaft 11a and a stator (not illustrated) surrounding the outer circumference of the rotor. Applied with a voltage (current), the motor generator 11 applies torque (power) to the shaft 11a about the first rotational center Ax1.

The transmission 12 is located between the motor generator 11 being an input and the wheels 13L and 13R being an output. The transmission 12, while coupled to the motor generator 11, is supported by the vehicle body.

The transmission 12 includes an input shaft 21, an output shaft 22, a plurality of gears 30, a gear connection mechanism 23, and a case 24. The case 24 accommodates the input shaft 21, the output shaft 22, the gears 30, and the gear connection mechanism 23. The case 24 is supported by the vehicle body. The input shaft 21 is an example of a first shaft and the output shaft 22 is an example of a second shaft.

The input shaft 21 and the output shaft 22 are spaced apart from each other in parallel. The input shaft 21 is rotatably supported by the case 24 about the first rotational center Ax1 while the output shaft 22 is rotatably supported by the case 24 about a second rotational center Ax2. The first rotational center Ax1 and the second rotational center Ax2 are also referred to as rotational axes.

The input shaft 21 is connected to the shaft 11a of the motor generator 11 and rotates integrally with, that is, simultaneously with the shaft 11a. Hereinafter, the direction of the rotation of the input shaft 21 when the vehicle 1 travels forward is referred to as a normal direction. The shaft 11a and the input shaft 21 does not need to be directly connected to each other and another rotation transmitting member such as a gear, a coupling, and a belt may be interposed therebetween. The shaft 11a and the input shaft 21 may not rotate at the same speed.

The gears 30 are constantly meshing gears and extend across the input shaft 21 and the output shaft 22. The gears 30 differ in gear ratio (reduction ratio). The gears are also referred to as gear pairs.

The gears 30 include a 1-speed gear 31 and a 2-speed gear 32. The 1-speed gear 31 and the 2-speed gear 32 are spaced from each other along the first rotational center Ax1 of the input shaft 21. The 2-speed gear 32 is lower in gear ratio than the 1-speed gear 31. The 1-speed gear 31 is also referred to as a low gear and the 2-speed gear 32 is also referred to as a high gear.

The 1-speed gear 31 includes a drive gear 33 and a driven gear 34 that mesh with each other, and the 2-speed gear 32 includes a drive gear 35 and a driven gear 36 that mesh with each other. The drive gear 33 is an example of a first gear, the driven gear 34 is an example of a second gear, the drive gear 35 is an example of a third gear, and the driven gear 36 is an example of a fourth gear.

The drive gears 33 and 35 are supported by the input shaft 21 through bearings (not illustrated) and rotate about the first rotational center Ax1 relative to the input shaft 21. Movement of the drive gears 33 and 35 along the first rotational center Ax1 is limited.

The transmission 12 further includes a one-way clutch 37 between the drive gear 33 of the 1-speed gear 31 and the input shaft 21. The one-way clutch 37 prohibits the input shaft 21 from normally rotating relative to the drive gear 33. The one-way clutch 37 can thus transmit normal rotation from the input shaft 21 to the drive gear 33. The one-way clutch 37 permits the drive gear 33 to normally rotate relative to the input shaft 21. The power of the motor generator 11 is transmitted to the drive gear 33 from the input shaft 21 through the one-way clutch 37 to rotate the input shaft 21 and the drive gear 33 in the normal direction. The normal direction is an example of a first direction.

The driven gears 34 and 36 are fixed to the output shaft 22 and rotate about the second rotational center Ax2 integrally with the output shaft 22.

The output shaft 22 is provided with a final gear 38. The final gear 38 is fixed to the output shaft 22 to rotate together about the second rotational center Ax2. The final gear 38 meshes with a differential ring gear 39a located in the case of a differential gear 39. The differential gear 39 is connected to the wheels 13L and 13R through drive shafts 40L and 40R.

The gear connection mechanism 23 includes a clutch mechanism 41 and a synchronizing mechanism 42. The clutch mechanism 41 and the synchronizing mechanism 42 are separated from each other. That is, the clutch mechanism 41 and the synchronizing mechanism 42 operate independently of each other.

The clutch mechanism 41 is located between the drive gear 33 of the 1-speed gear 31 and the drive gear 35 of the 2-speed gear 32. The synchronizing mechanism 42 is opposite to the drive gear 33 across the drive gear 35. Thus, the drive gear 35 is placed between the clutch mechanism 41 and the synchronizing mechanism 42.

The clutch mechanism 41 is a dog clutch mechanism that selectively switches connection (coupled) and disconnection (non-coupled) between the input shaft 21, and the drive gear 33 of the 1-speed gear 31 and the drive gear 35 of the 2-speed gear 32. That is, the clutch mechanism 41 switches the transmission and non-transmission of rotation between the input shaft 21 and the drive gear 33 and between the input shaft 21 and the drive gear 35.

The clutch mechanism 41 includes a hub 43 and a sleeve 44. The clutch mechanism 41 includes the one-way clutch 37 as well. The hub 43 is coupled to the input shaft 21 and rotates about the first rotational center Ax1 integrally with the input shaft 21. The sleeve 44 is coupled to the hub 43 by spline coupling, rotates about the first rotational center Ax1 integrally with the hub 43, and is movable along the axis of the input shaft 21 relative to the hub 43. Thus, the sleeve 44 rotates about the first rotational center Ax1 integrally with the input shaft 21 and is movable along the axis of the input shaft 21.

The sleeve 44 is located between the drive gear 33 of the 1-speed gear 31 and the drive gear 35 of the 2-speed gear 32. The sleeve 44 is an example of a second sleeve.

The sleeve 44 includes teeth 44a and teeth 44b. The teeth 44a are located on one end (right-side end in FIG. 1) of the sleeve 44 closer to the drive gear 33 and are aligned about the first rotational center Ax1. The teeth 44a can mesh with teeth 33a of the drive gear 33. The teeth 33a are located on part (left-side part in FIG. 1) of the drive gear 33 closer to the sleeve 44 to integrally rotate with the drive gear 33. The teeth 44b are located on one end (left-side end in FIG. 1) of the sleeve 44 closer to the drive gear 35 and are aligned about the first rotational center Ax1. The teeth 44b can mesh with teeth 35a of the drive gear 35. The teeth 35a are located on part (right-side part in FIG. 1) of the drive gear 35 closer to the sleeve 44 to integrally rotate with the drive gear 35. The teeth 33a, 35a, 44a, and 44b are dog teeth. The teeth 33a are an example of first teeth, the teeth 35a are an example of second teeth, the teeth 44a are an example of third teeth, and the teeth 44b are an example of fourth teeth.

The sleeve 44 is movable along the axis of the input shaft 21 relative to the input shaft 21. To be specific, the sleeve 44 is movable to a 1-speed mesh position (not illustrated), a non-mesh position (FIG. 1), and a 2-speed mesh position (not illustrated).

In the non-mesh position (FIG. 1) the teeth 44a of the sleeve 44 and the teeth 33a of the drive gear 33 do not mesh with each other, and the teeth 44b of the sleeve 44 and the teeth 35a of the drive gear 35 do not mesh with each other. The 1-speed mesh position is closer to the drive gear 33 (right side in FIG. 1) than the non-mesh position, and in the 1-speed mesh position the teeth 44a of the sleeve 44 and the teeth 33a of the drive gear 33 mesh with each other. The 2-speed mesh position is closer to the drive gear 35 (left side in FIG. 1) than the non-mesh position, and in the 2-speed mesh position the teeth 44b of the sleeve 44 and the teeth 35a of the drive gear 35 mesh with each other. That is, the sleeve 44 is not coupled to the drive gear 33 and the drive gear 35 in the non-mesh position, is coupled to the drive gear 33 in the 1-speed mesh position, and is coupled to the drive gear 35 in the 2-speed mesh position. The non-mesh position is also referred to as a neutral position.

While the sleeve 44 moves from the non-mesh position (FIG. 1) to the 2-speed mesh position (left side in FIG. 1), the sleeve 48 presses a synchronizer ring 49 toward the drive gear 35 to press a cone face 49b of the synchronizer ring 49 against a cone face 35b of the drive gear 35.

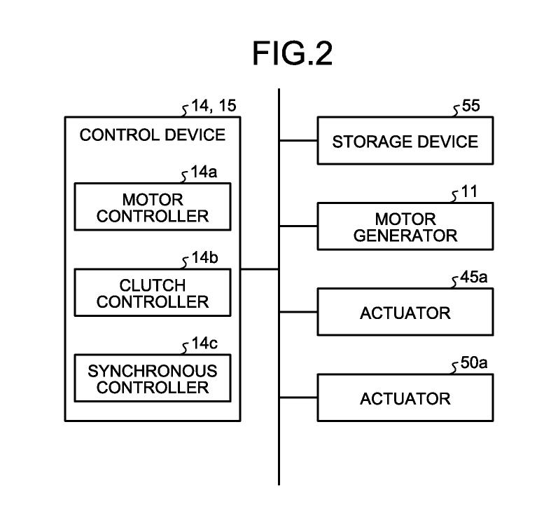

A first movement mechanism 45 can selectively move the sleeve 44 to any of the 1-speed mesh position with the drive gear 33, the 2-speed mesh position with the drive gear 35, and the non-mesh position. The first movement mechanism 45 includes an actuator 45a (FIG. 2) such as a motor and a transmission mechanism (not illustrated) that transmits driving power of the actuator 45a to the sleeve 44.

In the 1-speed mesh position where the sleeve 44 meshes with the drive gear 33, the input shaft 21 and the drive gear 33 are integrally rotatable. This forms a 1-speed transmission path from the input shaft 21 to the drive shafts 40L and 40R through the drive gear 33, the driven gear 34, the output shaft 22, the final gear 38, and the differential gear 39. In the first embodiment, the one-way clutch 37 also works to integrally rotate the input shaft 21 and the drive gear 33 in the normal direction. Thus, both of the one-way clutch 37 and the clutch mechanism 41 transmit rotation (power) from the input shaft 21 to the drive gear 33 while the vehicle 1 travels forward. A ratio of the power transmitted by the one-way clutch 37 and the power transmitted by the clutch mechanism 41 is set arbitrarily. The clutch mechanism 41 may transmit no power while the sleeve 44 is located at the 1-speed mesh position during the forward travel of the vehicle 1. The one-way clutch 37 transmits no power and the clutch mechanism 41 transmits power to the drive gear 33 from the input shaft 21 while the vehicle 1 travels backward.

In the 2-speed mesh position where the sleeve 44 meshes with the drive gear 35, the input shaft 21 and the drive gear 35 are integrally rotatable. This forms a 2-speed transmission path from the input shaft 21 to the drive shafts 40L, 40R through the drive gear 35, the driven gear 36, the output shaft 22, the final gear 38, and the differential gear 39.

As described above, the clutch mechanism 41 can be selectively switched to a 1-speed mesh state, a 2-speed mesh state, and a non-mesh state, In the 1-speed mesh state the teeth 44a of the sleeve 44 mesh with the teeth 33a of the drive gear 33 of the 1-speed gear 31 to integrally rotate the input shaft 21 and the drive gear 33. In 2-speed mesh state the teeth 44b of the sleeve 44 mesh with the teeth 35a of the drive gear 35 of the 2-speed gear 32 to integrally rotate the input shaft 21 and the drive gear 35. In the non-mesh state the teeth 44a and the teeth 33a as well as the teeth 44b and the teeth 35a do not mesh with each other to allow the input shaft 21 and each of the drive gear 33 and the drive gear 35 to relatively rotate. To be specific, in the non-mesh state the one-way clutch 37 allows the drive gear 33 to normally rotate relative to the input shaft 21.

The synchronizing mechanism 42 is interposed between the input shaft 21 and the drive gear 35. The synchronizing mechanism 42 is switched between a power transmission state (friction generation) and a power shut-off state (non-friction generation). In the power transmission state the synchronizing mechanism 42 generates friction force so that the rotation speed of the input shaft 21 and the rotation speed of the drive gear 35 approach each other. In the power shut-off state the synchronizing mechanism 42 generates no friction force. The synchronizing mechanism 42 can synchronize the rotation of the drive gear 35 and the rotation of the input shaft 21 through the friction force.

The synchronizing mechanism 42 includes a hub 47, a sleeve 48, and the synchronizer ring 49. The hub 47, the sleeve 48, and the synchronizer ring 49 are opposite to the sleeve 44 and the drive gear 33 across the drive gear 35. The sleeve 48 is an example of a first sleeve.

The synchronizer ring 49 is interposed between the sleeve 48 and the drive gear 35 and is rotatable relative to the drive gear 35 and movable along the axis of the input shaft 21.

The synchronizer ring 49 includes a pressed part 49a and the cone face 49b. The pressed part 49a is an annular flat face about the first rotational center Ax1. The pressed part 49a can contact with the sleeve 48 and is pressed by the sleeve 48. The cone face 49b can circumferentially slide with the cone face 35b of the drive gear 35, which rotate together, about the first rotational center Ax1. The sleeve 48 presses the cone face 49b against the cone face 35b to generate friction force therebetween. The cone face 35b is an example of a first cone face and the cone face 49b is an example of a second cone face.

The hub 47 is coupled to the input shaft 21 to integrally rotate about the first rotational center Ax1.

The sleeve 48 includes a pressing part 48a that presses the pressed part 49a of the synchronizer ring 49. The pressing part 48a is an annular flat face about the first rotational center Ax1. The sleeve 48 is coupled to the hub 47 by spline coupling to rotate together about the first rotational center Ax1 and be movable relative to the hub 47 along the axis of the input shaft 21. That is, the sleeve 48 integrally rotates with the input shaft 21 about the first rotational center Ax1 and is movable along the axis of the input shaft 21.

To be specific, the sleeve 48 is movable along the axis of the input shaft 21 between a press position (not illustrated) and a non-press position (FIG. 1). In the press position the sleeve 48 makes contact with the synchronizer ring 49 while in the non-press position (FIG. 1) the sleeve 48 is separated from the synchronizer ring 49. In the non-press position, the pressing part 48a and the pressed part 49a are separated from each other and the sleeve 48 does not press the cone face 49b against the cone face 35b. In the press position, the pressing part 48a and the pressed part 49a contact with each other and the sleeve 48 presses the cone face 49b against the cone face 35b. The press position is closer to the drive gear 35 (right side in FIG. 1) than the non-press position. A second movement mechanism 50 moves the sleeve 48 between the press position and the non-press position. The second movement mechanism 50 includes an actuator 50a (FIG. 2) such as a motor and a transmission mechanism (not illustrated) that transmits driving power of the actuator 50a to the sleeve 48. The non-press position is also referred to as a neutral position.

In the press position, the sleeve 48 presses the cone face 49b against the cone face 35b, placing the synchronizing mechanism 42 in the power transmission state. In the non-press position the sleeve 48 does not press the cone face 49b against the cone face 35b, placing the synchronizing mechanism 42 in the power shut-down state.

In the transmission 12 as configured above, the sleeve 48 is movable from the non-press position to the press position while the clutch mechanism 41 transmits rotation between the input shaft 21 and the drive gear 33 and transmits no rotation between the input shaft 21 and the drive gear 35. The clutch mechanism 41 can transmit rotation between the input shaft 21 and the drive gear 33 while the sleeve 48 moves from the non-press position to the press position.

FIG. 2 is an exemplary block diagram illustrating the schematic configuration of the vehicle 1 in the first embodiment. As illustrated in FIG. 2, the vehicle 1 includes a control device 14. The control device 14 and the transmission 12 constitute a power transmission system 15.

The control device 14 is connected to the motor generator 11, the actuator 45a of the first movement mechanism 45, and the actuator 50a of the second movement mechanism 50 to control them. The control device 14 is also connected to a storage device 55 and various sensors (not illustrated).

The control device 14 is, for example, an electronic control unit (ECU) including a processor such as a central processing unit (CPU). The processor of the control device 14 executes operations in accordance with a program installed in the storage device 55 to thereby implement various functions. The control device 14 can include hardware such as a field programmable gate array (FPGA) and an application specific integrated circuit (ASIC), and the hardware may control the respective elements.

The control device 14 includes, as functions, a motor controller 14a, a clutch controller 14b, and a synchronous controller 14c. These functions are implemented by the processor of the control device 14 which executes the program installed in the storage device 55. In the first embodiment, part or all of these functions may be implemented by dedicated hardware (circuit). The motor controller 14a controls the motor generator 11, the clutch controller 14b controls the clutch mechanism 41, and the synchronous controller 14c controls the synchronizing mechanism 42.

The storage device 55 includes, for example, a read only memory (ROM) and a random access memory (RAM). The storage device 55 may include a hard disk drive (HDD) and a solid state drive (SSD). The various sensors include a sensor that measures the speed of the vehicle 1, a sensor that measures the stepping amount of an accelerator pedal, and sensors that detect the positions of the sleeves 44 and 48.

Next, acceleration processing to be executed by the control device 14 at the time of a gear shift from the 1-speed gear 31 to the 2-speed gear 32 during acceleration of the vehicle 1 traveling forward will be described by way of example.

The acceleration processing is implemented in response to increase in the amount (stroke) of the driver's stepping on the accelerator pedal. Through the processing, the control device 14 controls the motor generator 11, the synchronizing mechanism 42, and the clutch mechanism 41 such that the acceleration of the vehicle 1 constantly exceeds zero while switching the 1-speed gear 31 to the 2-speed gear 32 during acceleration of the vehicle 1. The control device 14 controls the motor generator 11, the synchronizing mechanism 42, and the clutch mechanism 41 such that at least one of the synchronizing mechanism 42 and the clutch mechanism 41 constantly transmits power between the input shaft 21 and the output shaft 22 during a gear shift from the 1-speed gear 31 to the 2-speed gear 32, and that the motor generator 11 constantly generates torque for the period from start of the operation of each of the synchronizing mechanism 42 and the clutch mechanism 41 to the power transmission state of the synchronizing mechanism 42.

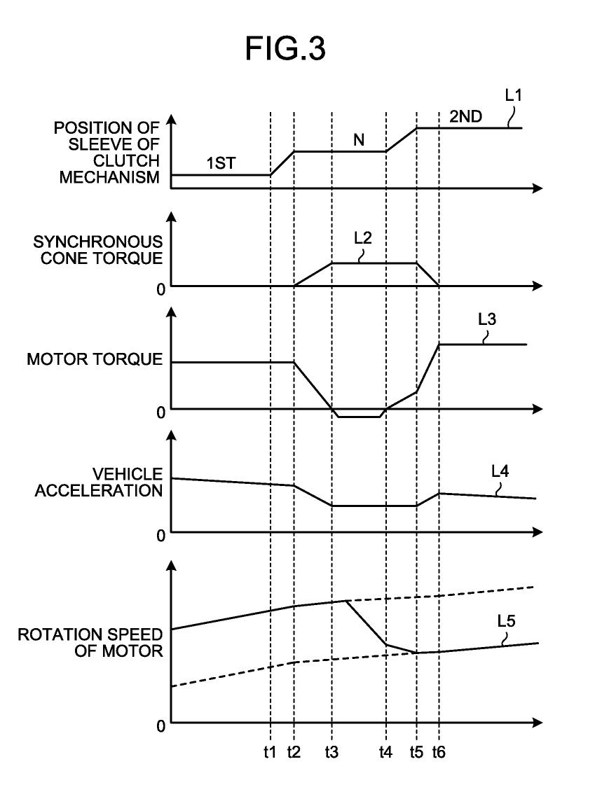

Hereinafter, the acceleration processing will be described in detail with reference to FIG. 3. FIG. 3 is an exemplary timing chart illustrating an example of the operation of the vehicle 1 in the first embodiment.

In FIG. 3, line L1 indicates variation in the position of the sleeve 44 of the clutch mechanism 41. Line L2 indicates variation in torque (hereinafter, also referred to as synchronous cone torque) that is transmitted between the cone face 49b of the synchronizer ring 49 and the cone face 35b of the drive gear 35. Line L3 indicates variation in torque (hereinafter, also referred to as motor torque) generated by the motor generator 11. Line L4 indicates variation in the acceleration of the vehicle 1. Line L5 indicates variation in the rotation speed (rotation rate) of the shaft 11a of the motor generator 11. The rotation speed (rotation rate) of the input shaft 21 varies similarly to the line L5. In FIG. 3, time elapses from time t1 to time t6.

In the example of FIG. 3, before time t1, the sleeve 44 is located in the 1-speed mesh position (1ST in FIG. 3) and the 1-speed gear 31 is selected. In this case, before time t2 the sleeve 48 is not located in the press position and the synchronizing mechanism 42 generates no synchronous cone torque. Before time t2, the control device 14 applies a predetermined positive voltage (current) to the motor generator 11 to accelerate the vehicle 1, which increases the rotation speed of the shaft 11a of the motor generator 11 over time.

When, for example, the rotation speed of the shaft 11a of the motor generator 11 reaches a predetermined rotation speed while the 1-speed gear 31 is selected, the clutch controller 14b controls the actuator 45a of the first movement mechanism 45 to move the sleeve 44 to the non-mesh position (N in FIG. 3) from the 1-speed mesh position (1ST). Thereby, the sleeve 44 starts moving to the non-mesh position (N) from the 1-speed mesh position (1ST) at time t1 and reaches the non-mesh position (N) at time t2. Time t1 represents the operation start time of the clutch mechanism 41. As described above, between time t1 and t2 the sleeve 48 is not located in the press position and no synchronous cone torque is generated. The reason why the sleeve 44 can move from the 1-speed mesh position (1ST) to the non-mesh position (N) under such condition is because both the one-way clutch 37 and the clutch mechanism 41 (the hub 43 and the sleeve 44) or the one-way clutch 37 alone transmits the rotation (power) from the input shaft 21 to the drive gear 33. The sleeve 44 is located in the non-mesh position (N) from time t2 to t4.

The synchronous controller 14c controls the actuator 50a of the second movement mechanism 50 to drive the synchronizing mechanism 42 to start generating the synchronous cone torque at time t2. The sleeve 48 of the synchronizing mechanism 42 thereby starts moving from the non-press position to the press position from time t1 and reaches the press position at time t2, by way of example. The time t1 represents the operation start time of the synchronizing mechanism 42 and time t2 represents the time at which the synchronizing mechanism 42 is placed in the power transmission state. From time t2 to t5, the synchronous controller 14c controls the actuator 50a to continuously apply force to the sleeve 48 so that the sleeve 48 moves from the non-press position to the press position. Thus, the synchronous cone torque rises over time (time t2 to t3). The synchronous cone torque reaches a predetermined upper limit value (threshold) and becomes constant (time t2 to t4). The predetermined upper limit value represents maximum transmissible torque (permissible torque) between the cone face 49b of the synchronizer ring 49 and the cone face 35b of the drive gear 35.

Next, the clutch controller 14b controls the actuator 45a of the first movement mechanism 45 to move the sleeve 44 from the non-mesh position (N) to the 2-speed mesh position (2ND in FIG. 3) at time t4 at which the synchronous cone torque exhibits the upper limit value. The sleeve 44 thereby starts moving from the non-mesh position (N) to the 2-speed mesh position (2ND) at time t4 and reaches the 2-speed mesh position (2ND) at time t5. That is, the gear is switched to the 2-speed gear 32 at time t5. In the first embodiment, the sleeve 44 is controlled to switch the gear to the 2-speed gear 32 before the synchronizing mechanism 42 completely synchronizes the rotation of the drive gear 35 and the rotation of the input shaft 21, that is, with a difference (differential rotation) in the rotation speed between the drive gear 35 and the input shaft 21.

The synchronous controller 14c controls the actuator 50a to drive the sleeve 48 to start moving from the press position to the non-press position for decreasing the synchronous cone torque, approximately simultaneously with the moving start of the sleeve 44 to the 2-speed mesh position (2ND) for the gear switch to the 2-speed gear 32 (time t5). The synchronous cone torque thereby falls to zero at time t6.

During the control over the sleeves, the motor controller 14a controls the motor generator 11 as follows. The motor controller 14a applies a voltage to the motor generator 11 to generate predetermined first motor torque before time t2 at which the synchronous cone torque is generated. That is, the motor controller 14a controls the synchronizing mechanism 42 and the clutch mechanism 41 to start operating at time t1, and the synchronizing mechanism 42 to be placed in the power transmission state at time t2, and controls the motor generator 11 to constantly generate torque from time t1 to t2.

The motor controller 14a controls the motor generator 11 to decrease the motor torque from time t2 at which the synchronous cone torque is generated. The motor controller 14a applies a voltage to the motor generator 11 to generate negative motor torque between time t3 and t4. For example, the motor controller 14a applies a negative voltage to the motor generator 11 to generate negative torque. Thus, generated negative torque can put a stop on the rotation of the shaft 11a of the motor generator 11 and the input shaft 21, so that the rotation speed of the input shaft 21 and the rotation speed of the drive gear 35 approach each other in a shorter period of time.

Subsequently, the motor controller 14a controls the motor generator 11 to increase the first motor torque to predetermined second torque larger than the first motor torque between time t4 to t6. To be specific, the motor controller 14a controls the motor generator 11 such that the increase rate of the motor torque is higher in the period of time t5 to t6 than in the period of time t4 to t5.

Through such motor torque control, the rotation speed of the shaft 11a of the motor generator 11 rises till past time t3 and decreases in the period of time t3 to t5, and rises again after time t5. When the motor generator 11 is an AC motor generator, motor controller 14a (the control device 14) controls the motor torque and the rotation speed of the motor generator 11 via the inverter.

Through the control and the operations of the respective elements, the power is transmitted between the input shaft 21 and the output shaft 22 and between the motor generator 11 and the wheels 13L and 13R from start of the switch or shift of the gear at time t1 to completion of the gear switch or shift at time t6. To be specific, from start of the gear switch at time t1 to rising of the synchronous cone torque of the synchronizing mechanism 42 at time t2, at least the one-way clutch 37 transmits power between the input shaft 21 and the drive gear 33 and between the input shaft 21 and the output shaft 22. In the period of time t2 to t6, at least the synchronizing mechanism 42 applies the synchronous torque to transmit the power between the input shaft 21 and the drive gear 35 and between the input shaft 21 and the output shaft 22. In the period of time t5 to t6, the clutch mechanism 41 also transmits the power between the input shaft 21 and the drive gear 35. Through these operations, the acceleration of the vehicle 1 exceeds zero from start to completion of the gear switch or shift at time t1 to time t6.

As described above, according to the power transmission system 15 in the first embodiment, the control device 14 controls the motor generator 11, the synchronizing mechanism 42, and the clutch mechanism 41 such that the acceleration of the vehicle 1 constantly exceeds zero while the 1-speed gear 31 is switched to the 2-speed gear 32 during acceleration of the vehicle 1. The control device 14 controls at least one of the synchronizing mechanism 42 and the clutch mechanism 41 to constantly transmit the power between the input shaft 21 and the output shaft 22 during the gear switch from the 1-speed gear 31 (first-speed gear) to the 2-speed gear 32 (second-speed gear), and controls the motor generator 11 to constantly generate torque from the operation start of each of the synchronizing mechanism 42 and the clutch mechanism 41 to the power transmission state of the synchronizing mechanism 42.

This configuration can prevent impact from being applied on the vehicle 1 during the gear switch, for example. In the gear switch from the 1-speed gear 31 to the 2-speed gear 32 during the acceleration of the vehicle 1, the acceleration of the vehicle 1 can be prevented from falling to zero.

In the power transmission system 15, while the clutch mechanism 41 transmits rotation between the input shaft 21 (first shaft) and the drive gear 33 (first gear) and transmits no rotation between the input shaft 21 and the drive gear 35 (third gear), the sleeve 48 is movable from the non-press position to the press position. The clutch mechanism 41 can transmit rotation between the input shaft 21 and the drive gear 33 while the sleeve 48 moves from the non-press position to the press position. With such a configuration, for example, at the time of a gear switch from the 1-speed gear 31 to the 2-speed gear 32 for acceleration of the vehicle 1, no power transmission between the input shaft 21 and the output shaft 22 can be prevented.

In the power transmission system 15, for example, the power of the motor generator 11 is transmitted from one of the input shaft 21 and the drive gear 33 (the input shaft 21 as an example) to the other (the drive gear 33 as an example) through the clutch mechanism 41, to normally (first direction) rotate the input shaft 21 and the drive gear 33. The clutch mechanism 41 includes the one-way clutch 37 that is interposed between the input shaft 21 and the drive gear 33 to transmit normal rotation from the one (input shaft 21) to the other (drive gear 33), and permits normal rotation of the other (drive gear 33) relative to the one (input shaft 21). Thereby, the one-way clutch 37 can transmit rotation between the input shaft 21 and the drive gear 33 while the sleeve 48 moves from the non-press position to the press position.

### Second Embodiment

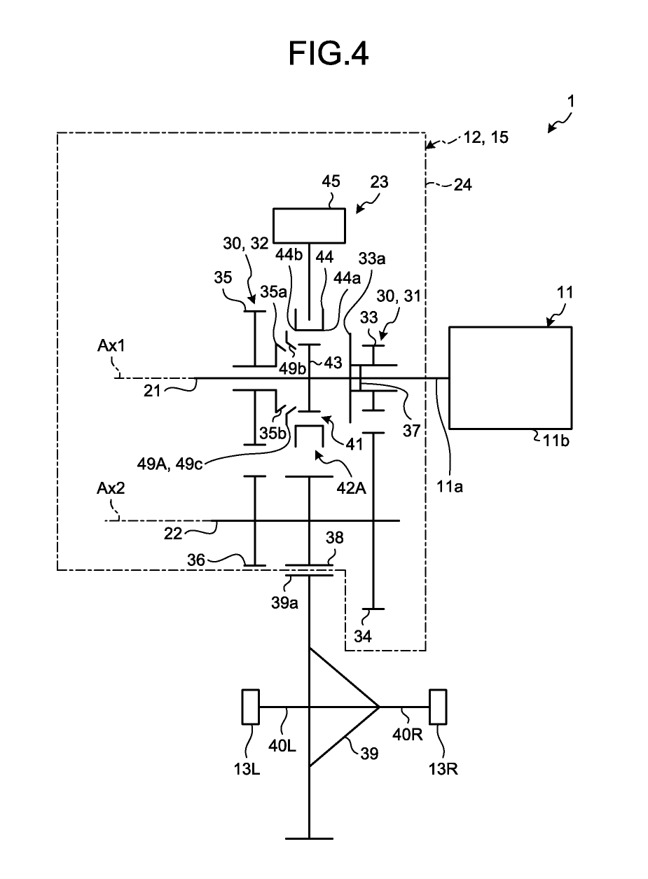

FIG. 4 is an exemplary diagram illustrating the schematic configuration of a vehicle 1 in a second embodiment. The vehicle 1 in the second embodiment is configured similarly to the vehicle 1 in the first embodiment. The second embodiment can thus attain similar effects based on the similar configurations, as with the first embodiment. In the following, the differences from the vehicle 1 in the first embodiment will be mainly described.

In the second embodiment, the vehicle 1 includes a synchronizing mechanism 42A instead of the synchronizing mechanism 42 in the first embodiment. The synchronizing mechanism 42A is located between the input shaft 21 and the drive gear 35. As with the synchronizing mechanism 42, the synchronizing mechanism 42A is switched between a power transmission state and a power shut-off state. In the power transmission state the synchronizing mechanism 42A generates friction force to allow the rotation speed of the input shaft 21 and the rotation speed of the drive gear 35 to approach each other. In the power shut-off state the synchronizing mechanism 42A generates no friction force. The synchronizing mechanism 42A can synchronize the rotation of the drive gear 35 and the rotation of the input shaft 21 by the friction force.

The synchronizing mechanism 42A includes a hub 43, a sleeve 44, and a synchronizer ring 49A. Thus, the hub 43 and the sleeve 44 are commonly used by the synchronizing mechanism 42A and the clutch mechanism 41. In the second embodiment, with no actuator 50a provided, the actuator 45a is commonly used by the synchronizing mechanism 42A and the clutch mechanism 41. The sleeve 44 is an example of a first sleeve and a second sleeve.

The synchronizer ring 49A is located between the sleeve 44 and the drive gear 35, and is rotatable relative to the drive gear 35 and movable along the axis of the input shaft 21.

The synchronizer ring 49A includes a cone face 49b and teeth 49c. The teeth 49c have chamfers that are pressed by chamfers of the teeth 44b of the sleeve 44. The chamfers of the teeth 49c are pressed by the chamfers of the teeth 44b of the sleeve 44 moving from the non-mesh position (1-speed mesh position) to the 2-speed mesh position, thereby pressing the cone face 49b against the cone face 35b of the drive gear 35 to generate friction force between the cone face 49b and the cone face 35b. This position of the sleeve 44 is a press position. By the friction force, the rotation of the drive gear 35 and the rotation of the input shaft 21 are synchronized with each other. After the synchronization, the teeth 44b of the sleeve 44 pass between the teeth 49c of the synchronizer ring 49A and mesh with the teeth 35a of the drive gear 35. Thus, while moving from the non-mesh position to the 2-speed mesh position, the sleeve 44 pushes the synchronizer ring 49A so as to press the cone face 49b against the cone face 35b. In the second embodiment, the non-mesh position or the 1-speed mesh position is an example of a non-press position.

As configured above, while the clutch mechanism 41 transmits rotation between the input shaft 21 and the drive gear 33 and transmits no rotation between the input shaft 21 and the drive gear 35, the sleeve 44 is movable from the non-mesh position, i.e., the non-press position to the press position. The one-way clutch 37 of the clutch mechanism 41 can transmit rotation between the input shaft 21 and the drive gear 33 while the sleeve 44 moves from the non-mesh position to the press position. The control device 14 hence controls the actuator 45a to move the sleeve 44 from the non-mesh position (non-press position) to the press position, whereby at least one of the synchronizing mechanism 42A and the clutch mechanism 41 can constantly transmit the power between the input shaft 21 and the output shaft 22 during a gear switch from the 1-speed gear 31 to the 2-speed gear 32.

As with the first embodiment, the control device 14 controls the motor generator 11, the synchronizing mechanism 42A, and the clutch mechanism 41 such that the acceleration of the vehicle 1 constantly exceeds zero while the 1-speed gear 31 is switched to the 2-speed gear 32 during acceleration of the vehicle 1.

The control device 14 controls the motor generator 11, the synchronizing mechanism 42A, and the clutch mechanism 41 such that at least one of the synchronizing mechanism 42A and the clutch mechanism 41 constantly transmits the power between the input shaft 21 and the output shaft 22 during a gear shift from the 1-speed gear 31 to the 2-speed gear 32, and that the motor generator 11 constantly generates torque for the period from start of the operation of each of the synchronizing mechanism 42 and the clutch mechanism 41 to the power transmission state of the synchronizing mechanism 42. Specifically, the control device 14 applies a voltage to the motor generator 11 for the period from the operation start of the synchronizing mechanism 42A and the clutch mechanism 41 to the contact between the cone face 49b and the cone face 35b, placing the synchronizing mechanism 42A in the power transmission state.

As described above, according to the second embodiment, the sleeve 44 and the actuator 45a are commonly used by the synchronizing mechanism 42A and the clutch mechanism 41, thereby enabling simplification and downsizing of the structure of the transmission 12.

### Third Embodiment

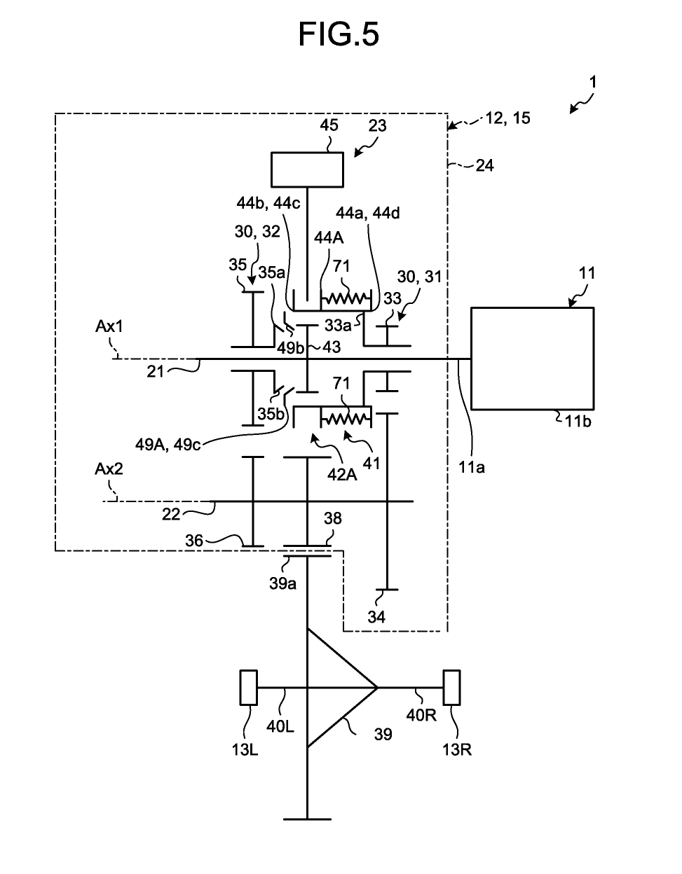

FIG. 5 is an exemplary diagram illustrating the schematic configuration of the vehicle 1 in a third embodiment. The vehicle 1 in the third embodiment is configured similarly to the vehicles 1 in the first and second embodiments. The third embodiment can thus attain similar effects based on the similar configurations as the first and second embodiments. Hereinafter, the differences from the vehicle 1 in the second embodiment will be mainly described.

In the third embodiment, the vehicle 1 includes a sleeve 44A instead of the sleeve 44 of the clutch mechanism 41 and the synchronizing mechanism 42A in the second embodiment. The one-way clutch 37 is omitted. The sleeve 44A is an example of a first sleeve and a second sleeve.

The sleeve 44A includes a 1-speed movable part 44d, a 2-speed movable part 44c, and a plurality of elastic members 71. The 1-speed movable part 44d is an example of a first movable part and the 2-speed movable part 44c is an example of a second movable part.

The 2-speed movable part 44c is a sleeve and includes teeth 44b. The 2-speed movable part 44c is located between the drive gear 33 and the drive gear 35.

The 2-speed movable part 44c is coupled to the hub 43 by spline coupling to integrally rotate about the first rotational center Ax1 and be movable along the axis of the input shaft 21 relative to the hub 43. That is, the 2-speed movable part 44c and the input shaft 21 integrally rotate about the first rotational center Ax1 and the 2-speed movable part 44c is movable along the axis of the input shaft 21. To be specific, the 2-speed movable part 44c is movable along the axis of the input shaft 21 between a 2-speed mesh position and a non-mesh position (FIG. 5) closer to the drive gear 33 than the 2-speed mesh position. In the 2-speed mesh position the teeth 44b and the teeth 35a mesh with each other while in the non-mesh position the teeth 44b and the teeth 35a do not mesh with each other.

The 2-speed movable part 44c pushes the synchronizer ring 49A so as to press the cone face 49b against the cone face 35b while moving from the non-mesh position to the 2-speed mesh position. This generates friction between the cone face 49b and the cone face 35b. This position of the 2-speed movable part 44c is a press position. By the friction force, the rotation of the drive gear 35 and the rotation of the input shaft 21 are synchronized with each other. After the synchronization, the teeth 44b of the 2-speed movable part 44c pass between the teeth 49c of the synchronizer ring 49A and mesh with the teeth 35a of the drive gear 35. The 2-speed movable part 44c is driven by the actuator 45a. In the third embodiment, the non-mesh position is an example of a non-press position and the 2-speed mesh position is an example of a mesh position.

The 1-speed movable part 44d is a sleeve and includes the teeth 44a. The 1-speed movable part 44d is larger in diameter than the 2-speed movable part 44c. In FIG. 5, the 1-speed movable part 44d is substantially the same in diameter as the 2-speed movable part 44c for the sake of convenience. The 1-speed movable part 44d is, for example, coupled to the 2-speed movable part 44c by spline coupling to integrally rotate about the first rotational center Ax1 and be movable along the axis of the input shaft 21 relative to the 2-speed movable part 44c. That is, the 1-speed movable part 44d and the input shaft 21 integrally rotate about the first rotational center Ax1 and the 1-speed movable part 44d is movable along the axis of the input shaft 21. To be specific, the 1-speed movable part 44d is be movable along the axis of the input shaft 21 between a 1-speed mesh position and a non-mesh position closer to the drive gear 35 than the 1-speed mesh position. In the 1-speed mesh position the teeth 44a and the teeth 33a mesh with each other while in the non-mesh position the teeth 44a and the teeth 33a do not mesh with each other. The 1-speed mesh position is an example of a mesh position and the non-mesh position is an example of a non-press position.

The elastic members 71 represent coil springs. The elastic members are disposed with spacing about the first rotational center Ax1 and connect the 1-speed movable part 44d and the 2-speed movable part 44c. The elastic members 71 generate force (elastic force) to move the 1-speed movable part 44d to the non-mesh position (left side in FIG. 5) when the 1-speed movable part 44d is located in the mesh position (FIG. 5) and the 2-speed movable part 44c is located in the non-mesh position. That is, the elastic members 71 generate force to move the 1-speed movable part 44d toward the 2-speed movable part 44c. The elastic members 71 are an example of a driver. The number of elastic members 71 may be one. The driver may include an actuator.

As configured above, in switching the gear from the 1-speed gear 31 to the 2-speed gear 32, the actuator 45a drives the 2-speed movable part 44c to move from the non-mesh position to the 2-speed mesh position and push the synchronizer ring 49A so as to press the cone face 49b against the cone face 35b, generating friction force between the cone face 49b and the cone face 35b. This reduces the rotation speed of the shaft 11a and the rotation speed of the drive gear 33, decreasing the power to be transmitted between the teeth 44a of the 1-speed movable part 44d and the teeth 33a of the drive gear 33. By the elastic force of the elastic members 71, the 1-speed movable part 44d is then separated from the teeth 33a of the drive gear 33 and moves to the non-mesh position. Thus, the elastic members 71 move the 1-speed movable part 44d to the non-mesh position by the elastic force, along with the motion of the 2-speed movable part 44c to the mesh position to press the cone face 49b against the cone face 35b. Thus, the control device 14 controls the actuator 45a to move the 2-speed movable part 44c from the non-press position to the press position, whereby at least one of the synchronizing mechanism 42A and the clutch mechanism 41 constantly transmits the power between the input shaft 21 and the output shaft 22 during the gear switch from the 1-speed gear 31 to the 2-speed gear 32.

As with the first and second embodiments, the control device 14 of the third embodiment controls the motor generator 11, the synchronizing mechanism 42A, and the clutch mechanism 41 such that the acceleration of the vehicle 1 constantly exceeds zero while the 1-speed gear 31 is switched to the 2-speed gear 32 during the acceleration of the vehicle 1.

The control device 14 controls the motor generator 11, the synchronizing mechanism 42A, and the clutch mechanism 41 such that at least one of the synchronizing mechanism 42A and the clutch mechanism 41 constantly transmits the power between the input shaft 21 and the output shaft 22 during a gear shift from the 1-speed gear 31 to the 2-speed gear 32, and that the motor generator 11 constantly generates torque for the period from start of the operation of each of the synchronizing mechanism 42 and the clutch mechanism 41 to the power transmission state of the synchronizing mechanism 42. Specifically, the control device 14 applies a voltage to the motor generator 11 for the period from the operation start of each of the synchronizing mechanism 42A and the clutch mechanism 41 to the contact between the cone face 49b and the cone face 35b, allowing the synchronizing mechanism 42A to generate friction force (power transmission state).

As described above, the vehicle 1 of the third embodiment includes the 1-speed movable part 44d (first movable part), the 2-speed movable part 44c (second movable part), and the elastic members 71 (driver). Thereby, the 1-speed movable part 44d can transmit rotation between the input shaft 21 and the drive gear 33 while the 2-speed movable part 44c moves to the press position from the non-mesh position being the non-press position.

The first to third embodiments have described the example that the drive gears 33 and 35 are rotatable relative to the input shaft 21 and the driven gears 34 and 36 are fixed to the output shaft 22 to rotate together. However, the invention is not limited to such an example. Alternatively, the drive gears 33 and 35 may be fixed to the input shaft 21 to integrally rotate while the driven gears 34 and 36 may be rotatable relative to the output shaft 22. In this case, the output shaft 22 (first shaft) is provided with the synchronizing mechanism 42 or 42A and the clutch mechanism 41. Also, the power of the motor generator 11 is transmitted from the driven gear 34 (one) to the output shaft 22 (the other) through the clutch mechanism 41.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power transmission system, comprising:
a transmission that is located between a motor generator and a wheel both of which are mounted on a vehicle; and
a control device, wherein
the transmission includes:
a first shaft that is rotatable;
a second shaft that is rotatable and parallel to the first shaft;
a first-speed gear having a first gear and a second gear, the first gear rotatably attached to the first shaft, the second gear attached to the second shaft to mesh with the first gear and integrally rotate with the second shaft;
a second-speed gear being smaller in gear ratio than the first-speed gear and having a third gear and a fourth gear, the third gear rotatably attached to the first shaft, the fourth gear attached to the second shaft, to mesh with the third gear and integrally rotate with the second shaft;
a synchronizing mechanism that is interposed between the first shaft and the third gear and to be switched between a power transmission state and a power shut-off state, the power transmission state being a state in which the synchronizing mechanism generates friction force that causes a rotation speed of the first shaft and a rotation speed of the third gear to approach each other, the power shut-off state being a state in which the synchronizing mechanism generates no friction force; and
a clutch mechanism that switches transmission and non-transmission of rotation between the first shaft and the first gear and between the first shaft and the third gear,
one of the first shaft and the second shaft is connected to the motor generator and the other is connected to the wheel, and
the control device controls the motor generator, the synchronizing mechanism, and the clutch mechanism such that at least one of the synchronizing mechanism and the clutch mechanism constantly transmits power between the first shaft and the second shaft during a gear switch from the first-speed gear to the second-speed gear, and that the motor generator constantly generates torque for a period from when each of the synchronizing mechanism and the clutch mechanism starts operating to when the synchronizing mechanism is placed in the power transmission state.

2. The power transmission system according to claim 1, wherein
the synchronizing mechanism includes:
a first cone face of the third gear, that integrally rotates with the third gear;
a synchronizer ring having a second cone face that is pressed against the first cone face to generate friction force with the first cone face; and
a first sleeve that is movable along an axis of the first shaft between a press position and a non-press position, and integrally rotates with the first shaft, the press position being a position in which the second cone face is pressed against the first cone face, the non-press position being a position in which the second cone face is not pressed against the first cone face,
the first sleeve is movable from the non-press position to the press position while the clutch mechanism transmits rotation between the first shaft and the first gear and transmits no rotation between the first shaft and the third gear, and
the clutch mechanism is configured to transmit rotation between the first shaft and the first gear while the first sleeve moves from the non-press position to the press position.

3. The power transmission system according to claim 1, wherein
the first shaft and the first gear are rotated in a first direction by power of the motor generator, and
the clutch mechanism includes a one-way clutch that is located between the first shaft and the first gear, transmits rotation in the first direction from the one of the first shaft and the second shaft to the other, and allows the other to rotate in the first direction relative to the one of the first shaft and the second shaft.

4. The power transmission system according to claim 2, wherein
the first-speed gear and the second-speed gear are spaced apart from each other along the axis of the first shaft, and
the clutch mechanism includes:
first teeth that integrally rotate with the first gear;
second teeth that integrally rotate with the third gear;
a first movable part that includes third teeth, is located between the first gear and the third gear, is movable along the axis of the first shaft between a first mesh position and a first non-mesh position, and integrally rotates with the first shaft, the first mesh position being a position in which the third teeth and the first teeth mesh with each other, the first non-mesh position being closer to the third gear than the mesh position and being a position in which the third teeth and the first teeth do not mesh with each other;
a second movable part that includes fourth teeth, is located between the first gear and the third gear, is movable along the axis of the first shaft between a second mesh position and a second non-mesh position and integrally rotates with the first shaft, and presses the second cone face against the first cone face while moving from the second non-mesh position to the second mesh position, the second mesh position being a position in which the fourth teeth and the second teeth mesh with each other, the second mesh position being closer to the first gear than the mesh position, and being a position in which the fourth teeth and the second teeth do not mesh with each other; and
a driver that connects the first movable part and the second movable part, generates force to move the first movable part to the first non-mesh position when the first movable part is located in the first mesh position and the second movable part is located in the second non-mesh position, and moves the first movable part to the non-mesh position by the force along with the motion of the second movable part to the second mesh position to press the second cone face against the first cone face.
